(19) United States
(12) Patent Application Publication
(10) Pub. No.: US 2014/0103181 A1
(43) Pub. Date: Apr. 17, 2014

(54) UNIVERSAL MOUNTING SYSTEM

(71) Applicant: SD & KEPHART LLC, Richmond, CA (US)

(72) Inventors: Swen Duerigen, Novato, CA (US); David Kephart, Sparks, NV (US)

(73) Assignee: SD & KEPHART LLC, Richmond, CA (US)

(21) Appl. No.: 13/792,108

(22) Filed: Mar. 10, 2013

Related U.S. Application Data
(60) Provisional application No. 61/713,575, filed on Oct. 14, 2012.

(51) Int. Cl. F16M 13/02

(52) U.S. Cl. CPC F16M 13/022
USPC 248/289.11

(57) ABSTRACT

A system and method for universally mounting a user's imaging solution(s). The universal mounting solution (sometimes referred to herein as the Velocity Clip) is a universal video mounting system for smartphones and digital cameras with video capabilities that turns them into a point of view camera. The Velocity Clip allows the user to attach their smartphone video device securely to their head, chest, or any hard or mobile surface with a gear mount by using a versatile mounting system (e.g., a set of straps or the like).

### CROSS REFERENCE TO RELATED APPLICATIONS

This application claims benefit of U.S. Application No. 61/713,575 filed 15 Oct. 2012, the contents of which is expressly incorporated herein in its entirety for all purposes.

### FIELD OF THE INVENTION

The present invention relates generally to mounting systems, and more specifically, but not exclusively, to universal mounting systems for portable imaging devices.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Smartphones are popular devices that have a capability to capture one or more images, including video recording modes. These devices increasingly have more powerful features and capabilities and users are using them in place of stand-alone dedicated equipment. Because the smartphone is frequently carried by a user as they perform a wide-range of functions and activities, with some of those activities including high impact sports and the like, there are users who desire to use the Smartphone to record those activities (e.g., first person and third person points of view). A design feature of the smartphone is portability which can be in conflict with mounting for hand's free video capture.

A further problem with the “smartphone” video camera or “compact digital camera” video camera is the inability to capture steady point of view footage from the forehead view, upper torso (chest) view, or mobile objects point of view; such as cars, boats, motorcycles, bicycles. Typically, when the user wants to capture point of view footage, they are required to buy specialized/proprietary mounts for a specific model of the video device. This can be very expensive, and if the user decides on upgrading their smartphone or compact digital camera, they would be forced to upgrade their mounting system, or create their own mount with duct tape or other items. The user may also choose to capture point of view footage by using their hand as a mount, which leaves the video quality unstable and the user without use of a hand. The user needs to be able to capture point of view footage hands free for safety issues. When the user has multiple filming devices, such as both a smartphone and a compact digital camera, there is no universal mount to accommodate recording for both devices.

What is needed is a system and method for universally mounting a user's imaging solution(s).

### BRIEF SUMMARY OF THE INVENTION

Disclosed is a system and method for universally mounting a user's imaging solution(s). The following summary of the invention is provided to facilitate an understanding of some of technical features related to smartphone mounting, and is not intended to be a full description of the present invention. A full appreciation of the various aspects of the invention can be gained by taking the entire specification, claims, drawings, and abstract as a whole. The present invention is applicable to other imaging solutions.

The universal mounting solution (sometimes referred to herein as the Velocity Clip) is a universal video mounting system for smartphones and digital cameras with video capabilities that turns them into a point of view camera. The Velocity Clip allows the user to attach their smartphone video device securely to their head, chest, or any hard or mobile surface with a gear mount by using a versatile mounting system (e.g., a set of straps or the like). It is desirable to capture point of view video from smartphones for a variety of advantages, mainly convenience. Smartphones allow you a wide range of applications including video stabilization, instant viewing, instant editing, and instant uploading to social media sites, among other applications. Velocity Clip also allows users to utilize other features of a smartphone including capturing photos, streaming live video, and using GPS, hands free. Embodiments of the Velocity Clip mount have no limits to which smartphone or compact digital camera the user may decide to use to capture video. The universal and adjustable housing system allows the user to upgrade their phone, without having to upgrade their video mounting system. Velocity Clip allows the user to attach their smartphone accessories of their choice. Such accessories may include protective or waterproof cases so underwater and extreme activities can be imaged while the electronic devices are protected. Other accessories may are custom smartphone lenses for the picture of their choice (wide angle, fish eye, color lenses).

A universal mount for a mounting accessory includes a clamp having a pair of clamping jaws separated by a clamping distance, said clamping distance selectively adjustable; a base including a quick connect/disconnect mechanical interface, said mechanical interface including a first portion coupled to said base wherein the mounting accessory includes a second portion complementary to said first portion and wherein said first portion includes a quick connect/quick release lock configured to be repeatably engaged with and disengaged from the second portion; and a swivel interconnect rotationally coupling said clamp to said base, said swivel interconnect including a swivel lock having a first configuration enabling a relative rotation between said clamp and said base and having a second configuration inhibiting said relative rotation.

Any of the embodiments described herein may be used alone or together with one another in any combination while achieving a point of view angle while filming hands free. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a perspective view of a universal mount;

FIG. 2 illustrates a side view of the universal mount of FIG. 1;

FIG. 3 illustrates a front view of the universal mount of FIG. 1;

FIG. 4 illustrates an exploded detail view of the universal mount of FIG. 1;

FIG. 5 illustrates an alternate swivel plate for use with a torso strap assembly;

FIG. 6 illustrates an alternative swivel plate for use with a head/headware strap assembly;

FIG. 7-FIG. 10 illustrate an alternate universal mount;

FIG. 7 illustrates a perspective view of the alternate universal mount;

FIG. 8 illustrates a side view of the alternate universal mount of FIG. 7;

FIG. 9 illustrates a front view of the alternate universal mount of FIG. 7;

FIG. 10 illustrates an exploded detail view of the alternate universal mount of FIG. 7;

FIG. 11-FIG. 12 illustrate a representative mounting accessory;

FIG. 11 illustrates a front part of a chest mount accessory including a female connector; and

FIG. 12 illustrates a rear part of the chest mount accessory.

### DETAILED DESCRIPTION OF THE INVENTION

Embodiments of the present invention provide a system and method for universally mounting a user's imaging solution(s). The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

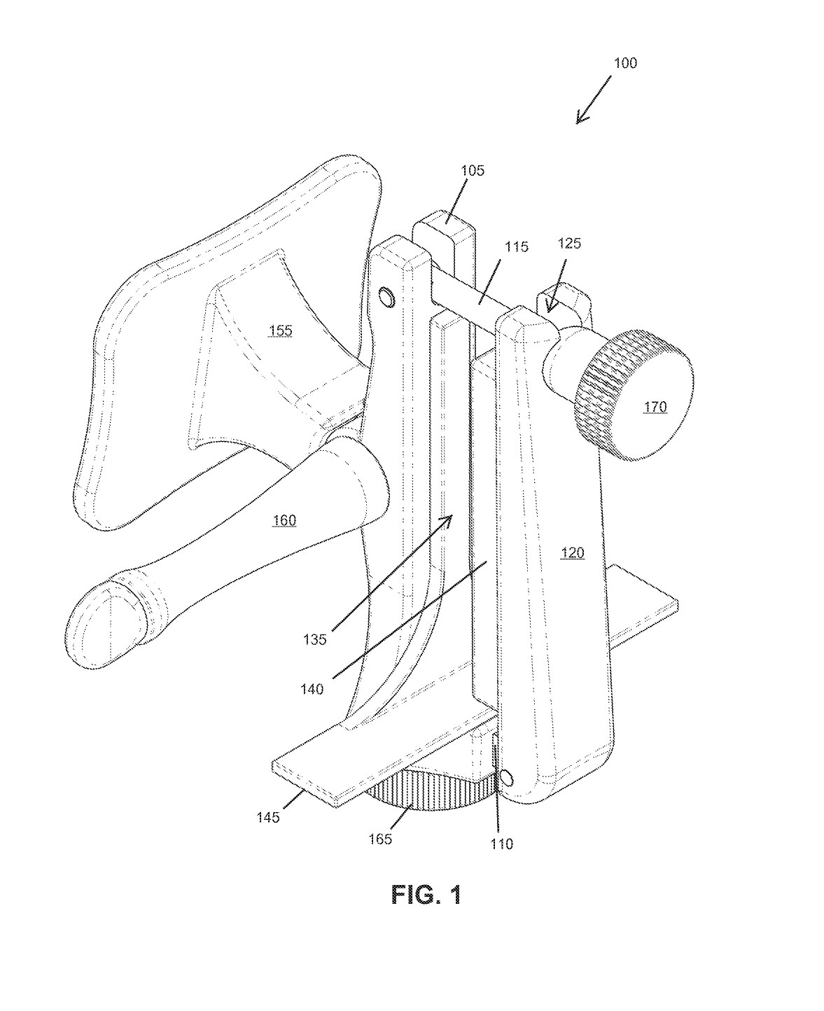

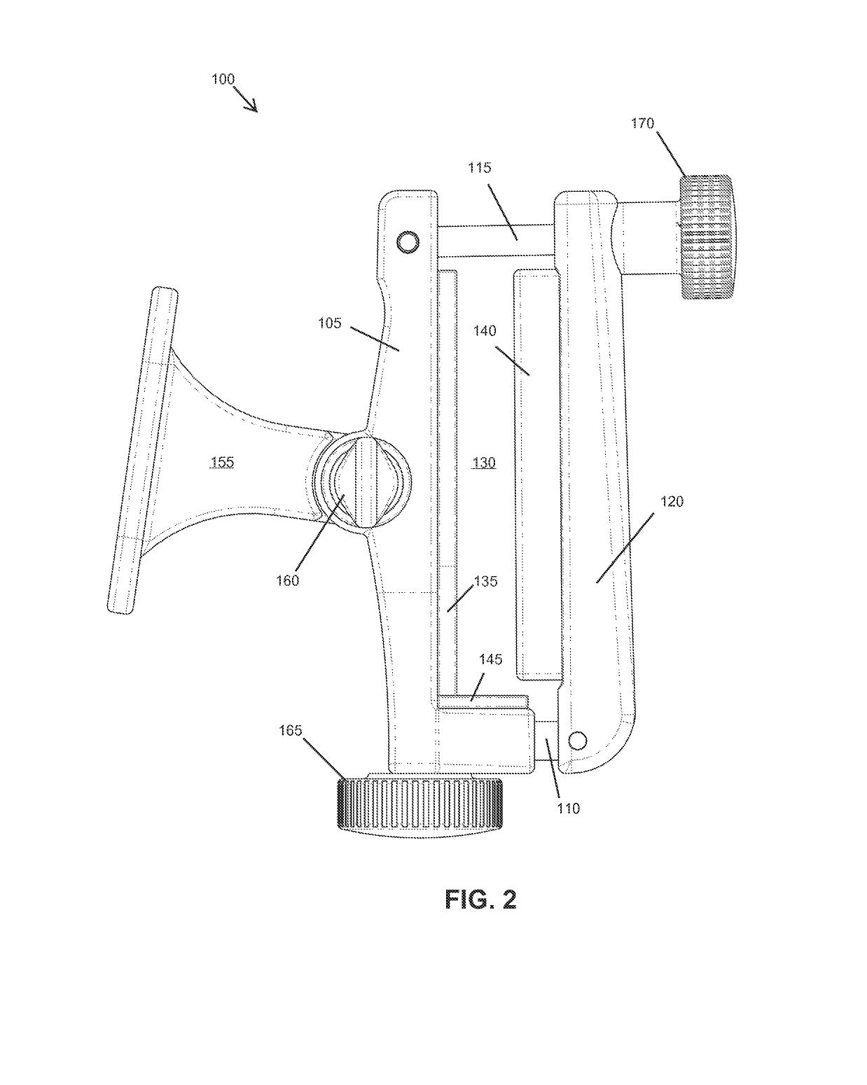

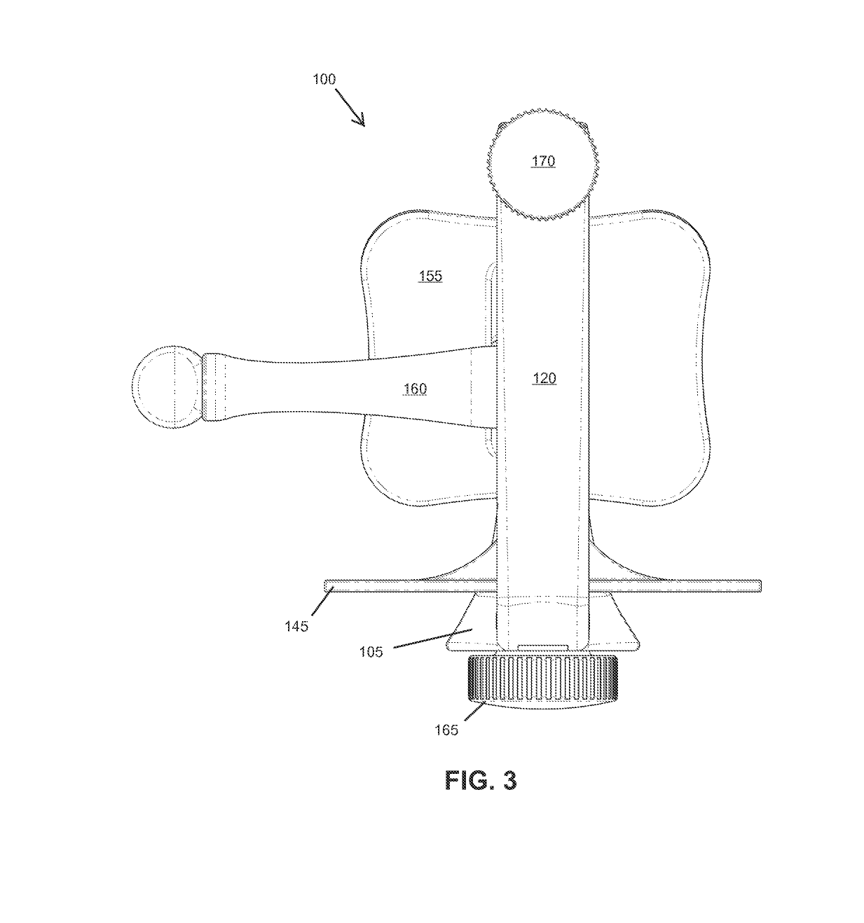

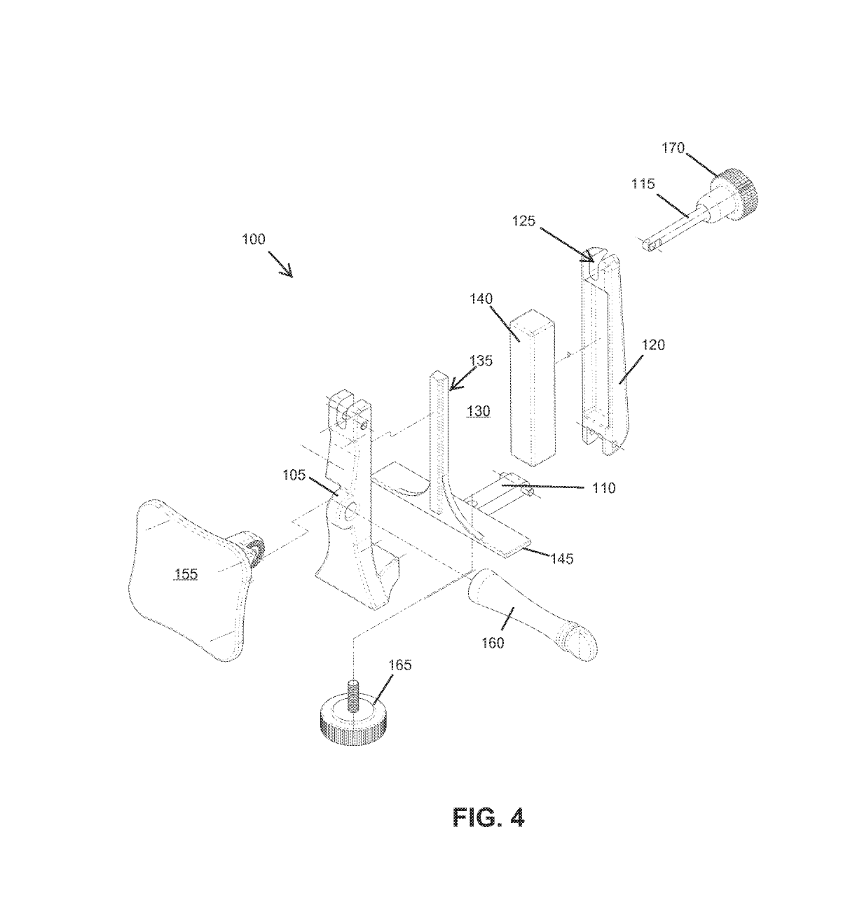

FIG. 1 illustrates a perspective view of a universal mount 100; FIG. 2 illustrates a side view of universal mount 100; FIG. 3 illustrates a front view of universal mount 100; and FIG. 4 illustrates an exploded detail view of universal mount 100. Universal mount 100 is configured to support and provide a desired point of view for an imaging device, such as a smartphone or other portable imager, particularly those that capture video.

Universal mount 100 includes a universal clamp and one more compatible mounts. The universal clamp includes a base 105 having a proximal end and a distal end, an inner arm 110 slidingly coupled to the proximal end and a locking bolt 115 pivotally coupled to the distal end. An outer arm 120 has a proximal end pivotally coupled to inner arm 110 and a distal end provided with a lock engagement structure 125 (e.g., a slot) for selectively engaging with locking bolt 115. A variable width capture zone 130 is defined between base 105 and outer arm 120. An inside surface of base 105 facing into capture zone 130 is optionally provided with a gripping attachment 135 and an inside surface of outer arm 120 facing into capture zone 130 is optionally provided with a gripping attachment 140. Inner arm 110 supports a stability shelf 145 which in turn supports the imager (In some embodiments, such as shown in FIG. 1-FIG. 4, gripping attachment 135 and stability shelf 145 are co-molded/co-formed and joined to base 105). A swivel plate 155 is moveably coupled to base 105 providing one or two degrees of freedom of relative movement (depending upon implementation) and an adjustment arm 160 for enabling and disabling adjustment of this movement. An adjustment knob 165 enables and disables a user's ability to extend/retract inner arm 110 relative to base 105, and thus a width of capture zone 130.

Most components of mount 100 may be made from molded polymer, including plastics and the like. Inner arm 110 slides relative to base 105 to control a width of capture zone 130, and therefore to adjust to a width of the imager, adapting to different sized housings. Knob 165 tightens and loosens inner arm 110 relative to base 105 to selectively enable and disable the relative sliding motion of inner arm 110.

Locking bolt 115 selectively engages slot 125 by rotating down into locking engagement to secure outer arm 120 into the locked position and rotating up to unlock outer arm 120. Outer arm 120 also rotates about its pivotal attachment to inner arm 110. The rotation enables outer arm 120 to move away from interference with placing imager on stability shelf 145 as well as removing the imager from this location. In the preferred embodiment, outer arm 120 rotates about ninety degrees, between horizontal and vertical positions.

Capture zone 130 is defined between base 105 and outer arm 120 (modified by any use of any optional gripper attachments) with its width varied by sliding inner arm 110 towards and away from base 105. Locking bolt 115 includes a knob 170 that enables locking bolt 115 to be secured in the locked mode, holding outer arm 120 secured in the closed and upright position and sandwiching the imager in capture zone 130 between base 105 and outer arm 120.

The grip attachments may be made from gripping material that provides a relative high coefficient friction and/or cushioning characteristic to safely hold the imager in capture zone 130 without damage. Rubberized, foams, and other such materials may be used.

Swivel plate 155 allows attachment to various mounting sub-systems, including attachment structures for engagement with a head, chest, equipment, and the like. These mounting subsystems may include adjustable strap assemblies and other engagement devices to securely attach to and holding swivel plate 155. Swivel plate 155 allows adjustment of a field of view of the imager held within capture zone 130. In the embodiment shown, a single vertical pivot is enabled allowing base 105 to have adjustable vertical angles (e.g., 110 degrees of movement). Other embodiments could include a ball and socket engagement allowing both vertical and horizontal adjustment. As shown, a pivotal coupling between base 105 and swivel plate 155 includes twenty-four engagement detent teeth to help secure the desired relative angle between them. Adjustment arm 160 in this mode tightens and loosens the relative engagement between base 105 and swivel plate 155 to disable and enable, respectively, angle adjustment. Adjustment arm 160 is shown elongate and extended in order to be accessible from behind an imager secured within capture zone 130 and swivel plate 155 engaged with a mounting sub-stem, such as the strap assembly securing base 105 to an upper torso of the user. Without the extension, adjustment arm 160 could be difficult to reach for adjustment.

The strap assembly, selectively engageable with, and disengageable from, swivel plate 155 enables base 105 to be secured in place against a torso, a head (or headwear), or other equipment or structures. Some strap assemblies and mounting solutions may optionally include an engagement plate, or equivalent, of their own, replacing swivel plate 155 rather than engaging it.

For a strap assembly, it may include strap position openings 1-4 in a plate with strap positioning configured in angles that best accommodate all sizes of users. Straps are adjustable to tighten to the upper torso of the body.

For a head mount assembly, it may include strap opening 1-3 in a plate with strap positioning configured in angles that best accommodate all sizes of users. Straps are adjustable to tighten to the upper head of the body or to headwear like a helmet or the like.

For a gear mount assembly, it may include a plate equipped with double sided adhesive, suction cup, or other engagement mechanism at the bottom base, allowing users to mount to any hard or approximately rigid surface, those surfaces may be stationary or mobile.

Other mounting sub-assemblies are possible for securing base 105 to a desired object, structure, surface, or the like.

In operation, a user may either secure base 105 to the desired object, structure, surface, or the like first and load the imager afterwards, or reverse this and load the imager first. Details of securing base 105 vary based upon the mounting sub-system and further details are not described in great herein. For example, a customized mounting plate 155 may be used to secure base 105 depending upon the how the user anticipates using universal mount 100. Details of loading and unloading the imager into universal mount 100 are provided below.

Rotate locking bolt 115 upwards from engagement with slot 125. It may be necessary to loosen knob 170 in order to allow locking bolt 115 to disengage from slot 125. Once locking bolt 115 has disengaged from slot 125, outer arm 120 may rotate downward and away from base 105 to open. The opened outer arm 120 exposes capture zone 130 and allows the user to place the imager onto stability shelf 145. Imagers come in many sizes, and the dimensions of smartphones and compact digital cameras vary widely. Mount 100 is designed for imagers that have an outward facing lens and that include a housing that is elongate and flat. For the embodiments described herein, it accommodates imagers up to 6 inches (15.24 centimeters) tall×2.75 inches (6.985 centimeters) wide, and 1 inch (2.54 centimeters) thick. Other configurations of the present invention may accommodate imagers with a range of dimensions that differ from these dimensions.

Before placing imager on stability shelf 145, or sometime thereafter prior to finally securing imager within capture zone 130, the user adjusts a width of capture zone 130. This width is adjusted by loosening knob 165 and sliding inner arm 110 towards or away from base 105 as appropriate.

The imager of the user's choice is placed onto stability shelf 145 with one or more desired lenses (some imagers have multiple lens) shifted within capture zone 130 so as to not be obscured by outer arm 120 when it is rotated upwardly.

Outer arm 120 is rotated upwardly and locking bolt 115 is pivoted into locking engagement with slot 125 to hold and secure the imager with capture zone 130. The user tightens knob 170, which safely compresses the imager between grip attachments until the imager is appropriately secure.

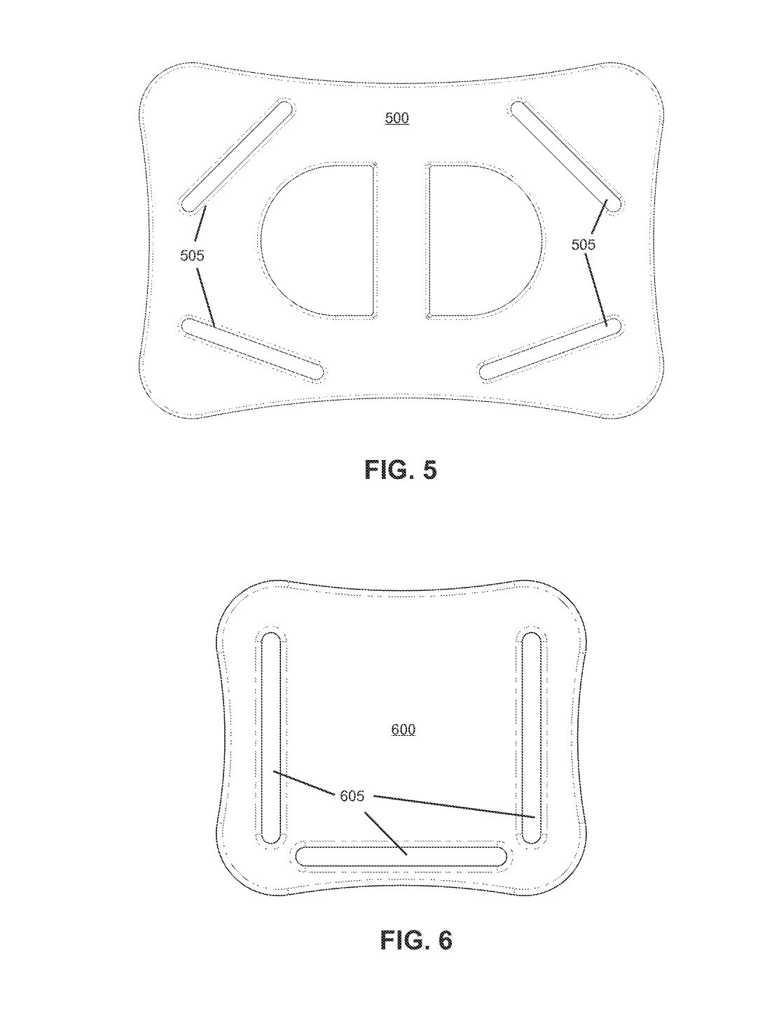

FIG. 5 illustrates an alternate swivel plate (e.g., a chest mount 500) for use with a torso strap assembly. Chest mount 500 attaches to base 105 in place of swivel plate 150 and also securely mounts to the upper torso of the body. The straps of the strap assembly are wrapped around the backside of the user crisscrossing for extra security. Two straps wrap around the shoulders, and two around the rear of the chest and couple to chest mount 500 using a set of strap apertures 505. The straps include adjustable clips to accommodate for all sizes of users. Once chest mount 500 is fastened securely to the user, the user may join base 105 and chest mount 500. (Note some embodiments have mount 500 attach to swivel plate 150 rather than replace it.) The user may then adjust the desired angle of the shot, and tighten adjustment arm 160.

FIG. 6 illustrates an alternative swivel plate (e.g., a head mount 600) for use with a head/headware strap assembly. Head mount 600 securely mounts to the forehead level of the body. The straps of the strap assembly are wrapped around the backside of the head/headware crisscrossing for extra security. One strap wraps horizontally around the sides of the head, and one strap moves directly over the crown of the head and couple to head mount 600 using a set of strap apertures 605. The straps include adjustable clips to accommodate for all sizes of users. Once head mount 600 is fastened securely to the user/headware, the user may join base 105 and head mount 600. (Note some embodiments have mount 600 attach to swivel plate 150 rather than replace it.) The user may then adjust the desired angle of the shot, and tighten adjustment arm 160.

The gear mount (e.g., swivel plate 150) securely mounts to any hard surface, mobile or stationary. The bottom of the gear mount is equipped with a double sided adhesive or suction cup. Once the gear mount is fastened securely, the user may join base 105 and swivel plate 155. The user may then adjust the desired angle of the shot, and tighten adjustment arm 160.

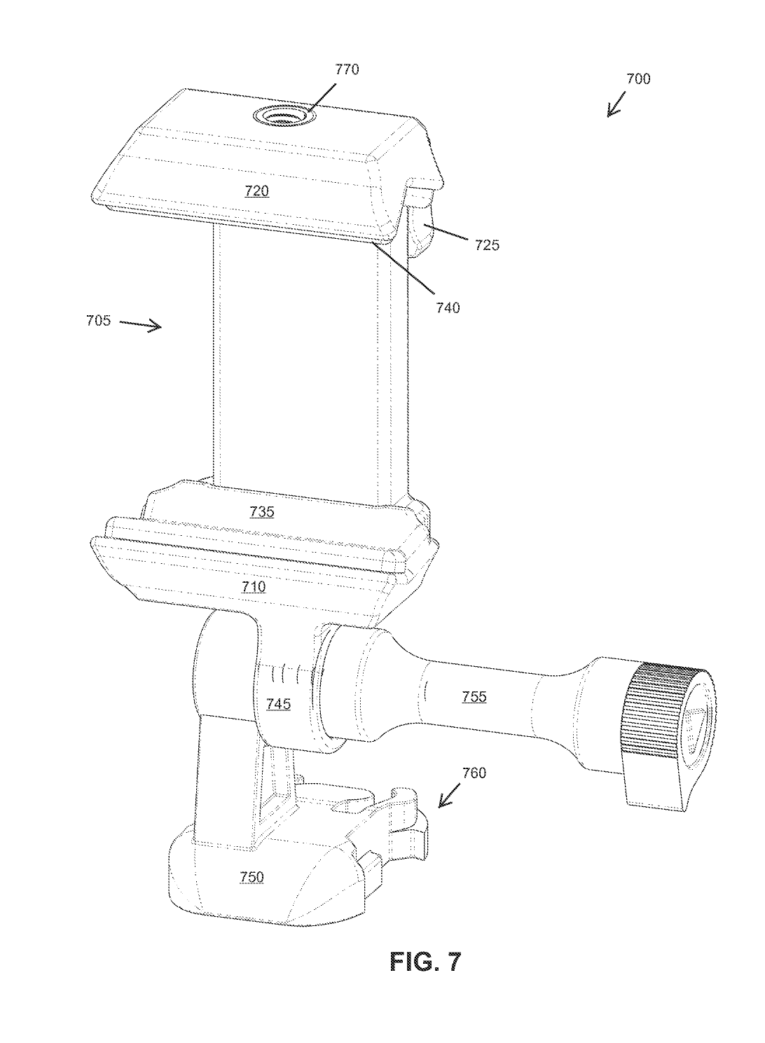

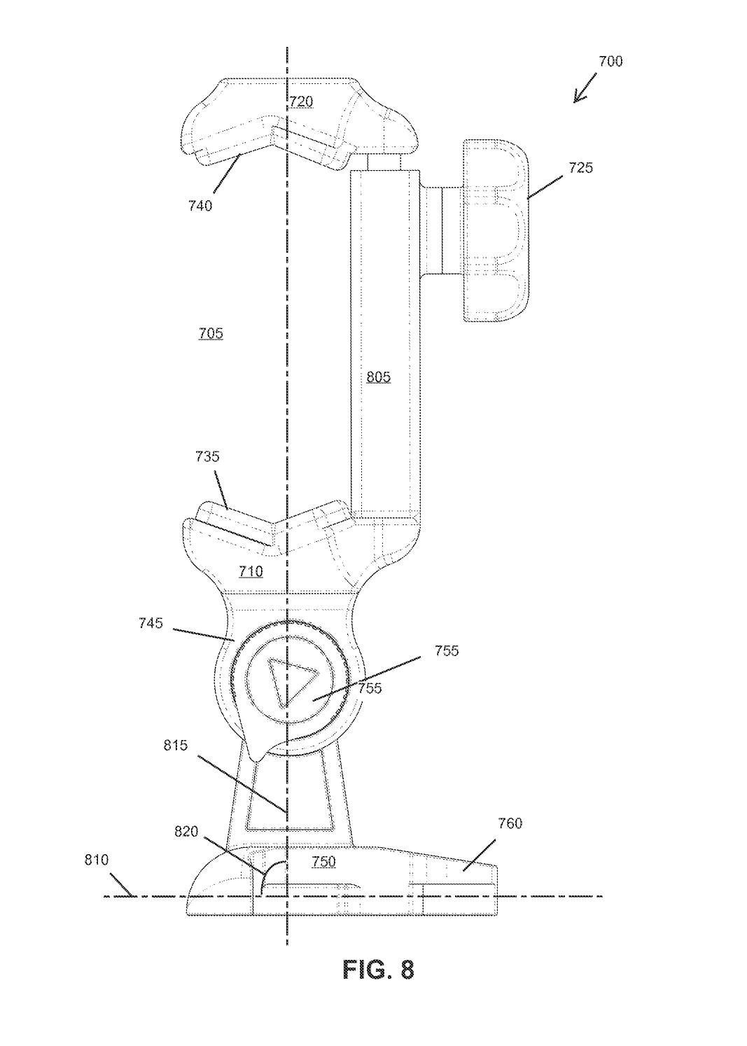

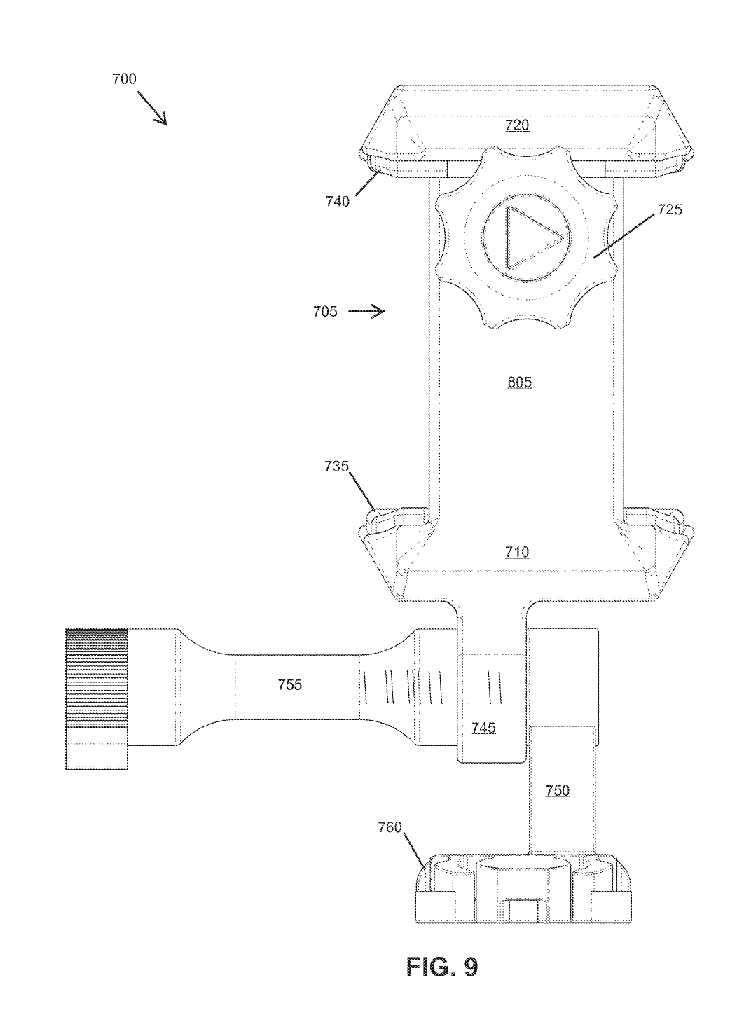

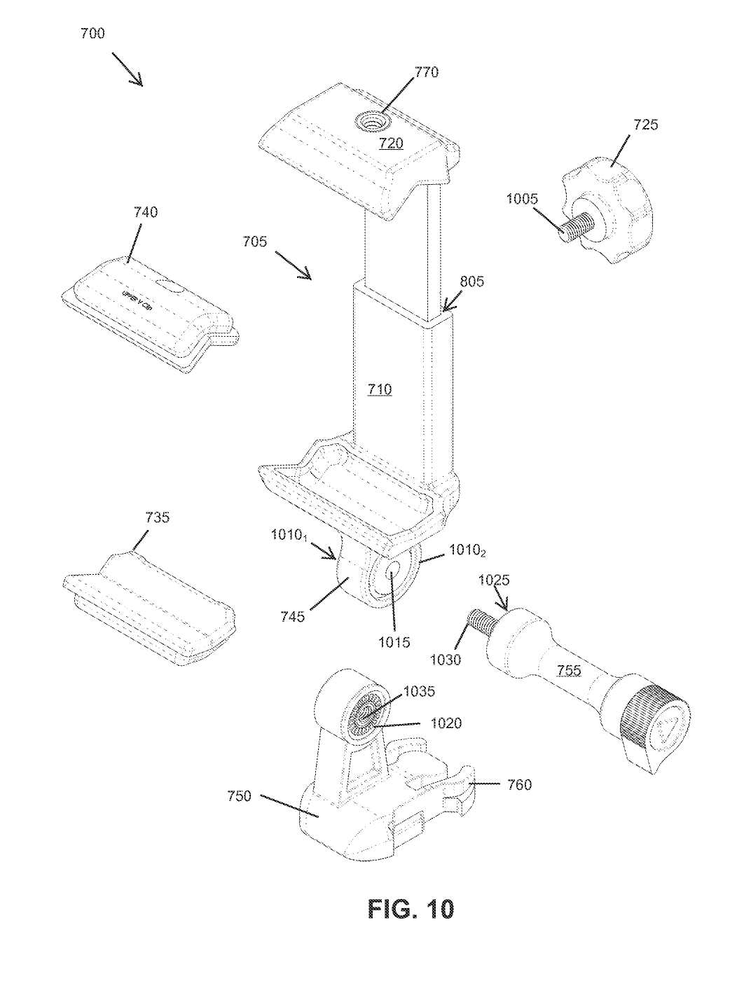

FIG. 7-FIG. 10 illustrate an alternate universal mount 700; FIG. 7 illustrates a perspective view of the alternate universal mount; FIG. 8 illustrates a side view of the alternate universal mount of FIG. 7; FIG. 9 illustrates a front view of the alternate universal mount of FIG. 7; and FIG. 10 illustrates an exploded detail view of the alternate universal mount of FIG. 7. Alternate universal mount 700 is configured to support and provide a desired point of view for an imaging device, such as a smartphone or other portable imager, particularly those that capture video. Except where expressly indicated to the contrary, or the context suggests otherwise, alternate universal mount 700 is constructed and operates similarly to universal mount 100 described herein.

Alternate universal mount 700 includes a clamp 705 having a lower clamp arm 710 including a channel 805 (FIG. 8) into which an upper clamp arm 720 is slidingly engaged. A tension knob 725 threadingly engaged with lower clamp arm 710 includes a threaded member 1005 (FIG. 10) that may extend into channel 805 to control a magnitude of extension of upper clamp arm 720 relative to lower clamp arm 710. A lower cushion pad 735 is coupled lower clamp arm 710 and an upper cushion pad 740 is coupled to upper clamp arm 720.

Lower clamp arm 710 includes a swivel control structure 745 that includes a pair of outward facing parallel toothed circular raceways 1010 (FIG. 10) with a center through-hole 1015 extending between the raceways 1010. One raceway 1010₁ is configured to mate to a complementary raceway 1020 on a gear buckle 750 and the other raceway 1010₂ is configured to mate to a complementary raceway 1025 on an angle adjustment knob 755. Angle adjustment knob 755 includes a threaded member 1030 extending through through-hole 1015 to engage a complementary threaded aperture 1035 in a center of complementary raceway 1020 of gear buckle 750. When engaged and tightened, the teeth engage complementary valleys in the mating surfaces of the raceways to inhibit any relative rotation of swivel control structure 745 and gear buckle 750. When the teeth are sufficiently loosened, relative rotation of swivel control structure 745 and gear buckle 750 is enabled.

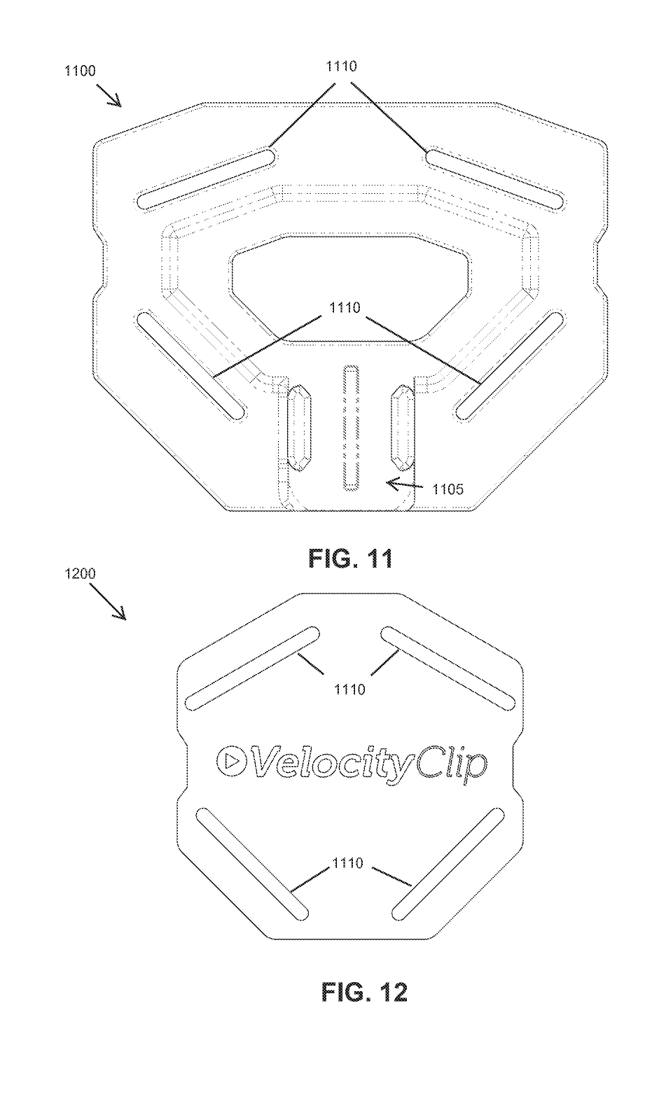

Gear buckle 750 includes a first portion of a mechanical interface used to join alternate universal mount to people, clothing, helmets, and other objects. Illustrated in FIG. 7-FIG. 11, the mechanical interface includes quick connect/disconnect snap buckles, with the first portion including a male connector 760. Other equipment and devices configured to cooperate with alternate universal mount 700 include a second portion of the mechanical interface that securely engages and retains the first portion, locking gear buckle 750 to such other equipment and devices. For example, in some implementations, the second portion may include a female connector 1105 (FIG. 11) complementary to male connector 760.

As shown, male connector 760 includes a thin elongate central member and a set of lateral spring arms. Female connector 1105 includes a thin elongate central slot and a set of lateral arm engagement slots complementary to the thin elongate central member and set of lateral arms, respectively. This connection system helps to inhibit unintended rotation of alternate universal mount 700 relative to the attached mounting accessory.

Upper clamp arm 720 includes a male side of clamp 705 that adjusts vertically (sliding in and out of channel 805 of lower clamp arm 710) to accommodate different sized imagers/pointing devices (e.g., a SmartPhone, tablet computer, portable electronic devices with a camera, and the like). Each of the clamp arms support a cushion pad that may be natural or synthetic rubber or other elastomer. The cushion pads fit directly into their respective clamp arms and are preferred to be tacky and designed to hold the imager/pointing device in place when tension is applied from closing clamp 705.

A top surface of upper clamp arm 720 includes threaded insert 770. Insert 770 is implemented as a 1/4″ 20 thread compatible with a standard threaded element used with tripods and other camera/imager mounting systems. Insert 770 disposed in a top surface of upper clamp arm 720 allows alternate universal mount 700 to be turned upside down, mounted to a tripod with standard threads. Once mounted to a tripod, any smartphone or image may be clamped inside clamp 705. This allows use of alternate universal mount 700 as a universal tripod mount.

Gear buckle 750 includes a base that attaches to lower clamp arm 710. Gear buckle 750 attaches to all accessories including a head mount, chest mount, or sticky mount, among other mounting accessories. Gear buckle 750 includes the “male” end of the mechanical interface and the accessories have the complementary “female” receiving end allowing the user to buckle/release alternate universal mount 700 from accessory to accessory.

Tension knob 725 turns one direction to tighten threaded member 1005 against upper clamp arm 720 within channel 805 and turns another direction to loosen threaded member 1005 from engagement against upper clamp arm 720. A portion of lower clamp arm 710 includes a female receiving structure or insert for threaded member 1005.

Angle adjustment knob 755 controls a rotation of alternate universal mount 700 as it is configured to swivel roughly 180 degrees and be locked into any desired angle in these limits by tightening angle adjustment knob 755. FIG. 8 illustrates two planes extending out of the page. An engagement plane 810 defined by the first portion of the mechanical interface joining alternate universal mount 700 to a compatible accessory. A clamping plane 815 defined by a line passing through clamp 705 and passing through a center of rotation of clamp 705 relative to gear buckle 750. The center of rotation is typically aligned with a longitudinal axis of threaded member 1030. An angle 820 between engagement plane 810 and clamping plane 815 is variable and set by an amount of rotation of clamp 705 about the center of rotation. As illustrated in FIG. 8, angle 820 forms a right angle and may vary at least plus/minus ninety degrees from this orientation (though other implementations may provide for more or less relative rotation). In other words, clamping plane 815 may be parallel to engagement plane 810 with an opening of clamp 705 facing either up or down depending upon which way clamping plane 815 was rotated.

In operation, a user operates alternate universal mount 700 to secure, point, and hold an imager/pointing device. Different imagers have different dimensions of length, height, and width. The user loosens tension knob 725 to allow upper clamp arm 720 to slide relative to lower clamp arm 710. The sliding allows the user to adjust a distance between a pair of cushioned jaws of alternate universal mount 700 to accommodate the desired vertical distance between ends of the imager in its preferred orientation (as the user may prefer that an imager is oriented so a longest dimension is vertical or horizontal, the distance between the cushioned jaws may be increased or decreased as necessary or desirable). The imager is placed into position between the cushioned jaws and upper clamp arm 720 is slid toward lower clamp arm 710 which closes clamp 705 to securely grip the imager. The user then tightens tension knob 725 to fix clamp 705 closed to retain the imager within the jaws.

When not already done, gear buckle 750 is rotationally coupled to swivel control structure 745 using knob 755. The user sets a desired relative angle between clamp 705 and gear buckle 750 by relatively rotating the two elements. When the desired angle is attained, knob 755 is tightened which inhibits any further relative rotation.

When not already done, male connector 760 is snapped into a female connector of any compatible mounting system (e.g., a chest mount, sticky mount, bike mount, head/helmet mount, and the like). Once engaged to the compatible mounting system, the user may need or desire to adjust the relative angle between gear buckle 750 and clamp 705 as that will then adjust a relative angle between the compatible mounting system and clamp 705 and thereof determine a direction the image capturing system of the imager points.

FIG. 11-FIG. 12 illustrate a representative mounting accessory; FIG. 11 illustrates a front part 1100 of a chest mount accessory including a female connector 1105; and FIG. 12 illustrates a rear part 1200 of the chest mount accessory. Each part includes a set of slots 1110 that accept a set of straps (not shown) that wrap around a torso of a user and secure front part 1100 to a chest of the user and secure rear part 1200 to a back of the user. In this arrangement, female connector 1105 is maintained fixed in the user's frame of reference. Mounting male connector 760 to female connector 1105 fixes alternate universal mount 700 into the user's frame of reference allowing the user to fix a field of view of an imager clamped into clamp 705 to follow the user's movements.

Various specific locking mechanisms have been described herein (for example, threaded member 1005 selectively engaging and releasing against upper clamp arm 720 to control a clamp jaw opening width or interlocking parallel raceways for swivel control) that may be implemented in different fashion while still falling within the scope of the present invention. The disclosed swivel control controlling a rotational angle of the clamping plane relative to the engagement plane provides single degree of freedom. Other coupling systems may provide 2 or more degrees of freedom (e.g., two or more of pitch, yaw, and roll) between clamp 705 and gear buckle 750, with individual joints or in a kinematic chain of a succession of discrete joints joined by rigid links.

The system and methods above has been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A universal mount for a mounting accessory, comprising:
a clamp having a pair of clamping jaws separated by a clamping distance, said clamping distance selectively adjustable;
a base including a quick connect/disconnect mechanical interface, said mechanical interface including a first portion coupled to said base wherein the mounting accessory includes a second portion complementary to said first portion and wherein said first portion includes a quick connect/quick release lock configured to be repeatably engaged with and disengaged from the second portion; and
a swivel interconnect rotationally coupling said clamp to said base, said swivel interconnect including a swivel lock having a first configuration enabling a relative rotation between said clamp and said base and having a second configuration inhibiting said relative rotation.

2. The universal mount of claim 1 wherein said clamp includes a first clamp arm having one of said pair of jaws and a second clamp arm having another one of said pair of jaws, said first clamp arm slidingly coupled to said second clamp arm wherein a relative sliding between said clamp arms sets said clamping distance, said clamp further including a locking mechanism that inhibits a change of said clamping distance in a clamp lock configuration and that uninhibits said change of said clamping distance in a clamp unlock configuration.

3. The universal mount of claim 2 wherein said first clamp arm slides relative to said second clamp arm within a channel of said second clamp arm and wherein said locking mechanism includes a threaded element that selectively enters into said channel to engage said first clamp arm within said channel in said clamp lock configuration and exits from said channel in said clamp unlock configuration.

4. The universal mount of claim 2 wherein said clamp arms slide relative to each other within a clamping plane and wherein said mechanical interface defines an engagement plane between said portions of said mechanical interface, and wherein said swivel interconnect controls a relative angle between said clamping plane and said engagement plane.

5. The universal mount of claim 4 wherein said clamping plane and said engagement plane have a range of relative rotation of at least 180 degrees.

6. The universal mount of claim 5 wherein said relative angle includes at least one of zero degrees and 180 degrees.

7. A method for pointing an imager relative to an object, the imager having a lens providing a field of view, comprising:
a) clamping the imager between a pair of opposing jaws of a clamp, the clamp not obscuring the field of view wherein said pair of opposing jaws of said clamp define a clamping plane;
b) coupling rotatably said clamp to a gear buckle using a rotation control, said rotation control providing a rotation axis disposed within, or parallel to, said clamping plane; and
c) mounting said gear buckle to a mounting accessory coupled to the object, said gear buckle including a first portion of a mechanical interface and said mounting accessory including a second portion of said mechanical interface, said second portion of said mechanical interface complementary to said first portion of said mechanical interface.

8. The pointing method of claim 7 wherein an engagement of said portions of said mechanical together define an engagement plane that does not intersect said rotation axis.

9. The pointing method of claim 8 wherein an angle between said clamping plane and said engagement plane varies over a range of angles at least equal to 180 degrees.
